(19) United States
(12) Patent Application Publication
(10) Pub. No.: US 2005/0052467 A1
(43) Pub. Date: Mar. 10, 2005

(54) Information processing apparatus and character display controlling method

(76) Inventor: Tatsuya Komuro, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/926,350

(22) Filed: Aug. 26, 2004

(30) Foreign Application Priority Data
Aug. 29, 2003 (JP) 2003-308087

(51) Int. Cl. G09G 5/00

(52) U.S. Cl. 345/611

(57) ABSTRACT

A display controller is a display device comprising an α channel and having a function of synthesizing two images of plane X and plane Y at a mixture ratio of plane α. When a character is superposed on the image of plane Y, an anti-aliasing program clears plane α as initial setting and subjects the character to be displayed to anti-aliasing to form gray scale font data. Then, the anti-aliasing program fills a character display area of plane X with a display color and transfers the formed gray scale font data to plane α.

### CROSS-REFERENCE TO RELATED APPLICATIONS

This application is based upon and claims the benefit of priority from prior Japanese Patent Application No. 2003-308087, filed Aug. 29, 2003, the entire contents of which are incorporated herein by reference.

### BACKGROUND OF THE INVENTION

1. Field of the Invention

The present invention relates to an information processing apparatus and a character display controlling method for displaying an image including a character on a display device such as a cathode-ray tube (CRT) display or a liquid crystal display (LCD).

2. Description of the Related Art

In recent years, personal computers of various types such as a desktop type and a notebook type have become widespread. The personal computers of these types have a function of displaying various kinds of images formed by software on a display device, for example, a CRT display, an LCD or the like.

If vector data or bitmap data such as a character is displayed as binary data, i.e. a character color and a background color only, on the display device, jaggies (rough outlines) become noticeable. Thus, the image displaying function generally employs anti-aliasing to remove jaggies. With anti-aliasing, a middle color between the character color and the background color is painted at the jaggies.

As anti-aliasing requires an operation to calculate the middle color, much time is spent for painting, which may occasionally give a bad influence to a CPU and other computer components. To solve this problem, various methods of accelerating anti-aliasing have been developed (see, for example, Jpn. Pat. Appln. KOKAI Publication No. 2002-341855).

Conventional anti-aliasing methods including Jpn. Pat. Appln. KOKAI Publication No. 2002-341855 are substantially based on the following principle. For example, if deepness of the character color is represented by α (0≦α≧1), the character color is represented by A, the background color is B and the painted color is C, C is represented by:
C=A×α+B×(1−α) (Equation 1)
and R (red), G (green) and B (blue) of the painted color C are calculated by Equation 1. By using the deepness α of the character color, total amounts of operations are reduced and anti-aliasing is accelerated.

However, the software operated in the personal computer has become multifunctional to form a more complicated image. Therefore, the background colors displaying a character have become more various than ever. In accordance with this, the capability of the CPU controlling anti-aliasing has been gradually limited.

### BRIEF SUMMARY OF THE INVENTION

According to an embodiment of the present invention, an information processing apparatus comprises a display device, an anti-aliasing unit configured to subject character data to be displayed on the display device to anti-aliasing, a synthesizing unit configured to synthesize first display data to be displayed on the display device and second display data to be displayed on the display device in accordance with mixture ratio data representing a mixture ratio of a display color of the first display data to a display color of the second display data, and a display controlling unit configured to supply the character data subjected to anti-aliasing by the anti-aliasing unit to the synthesizing unit as the mixture ratio data in order to cause the synthesizing unit to generate display data superposing the character data, subjected to anti-aliasing, painted in the display color of the first display data on the background composed of the second display data, and display the generated display data on the display device.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an illustration showing a configuration of display control of an information processing apparatus according to an embodiment of the present invention;

FIG. 2 is a schematic illustration showing a display device having a channel;

FIG. 3 is a schematic illustration showing a principle of character display control executed in the information processing apparatus;

FIG. 4 is a first illustration showing a concrete example of a character display controlling method in the information processing apparatus;

FIGS. 5A to 5C are second illustrations showing the concrete example of the character display controlling method in the information processing apparatus;

FIG. 6 is a flowchart showing steps of the character display controlling method in the information processing apparatus; and

FIG. 7 is a flowchart showing steps of the character display controlling method in the information processing apparatus in a case of displaying a patterned character subjected to anti-aliasing.

### DETAILED DESCRIPTION OF THE INVENTION

An embodiment of the present invention will be explained below with reference to the accompanying drawings.

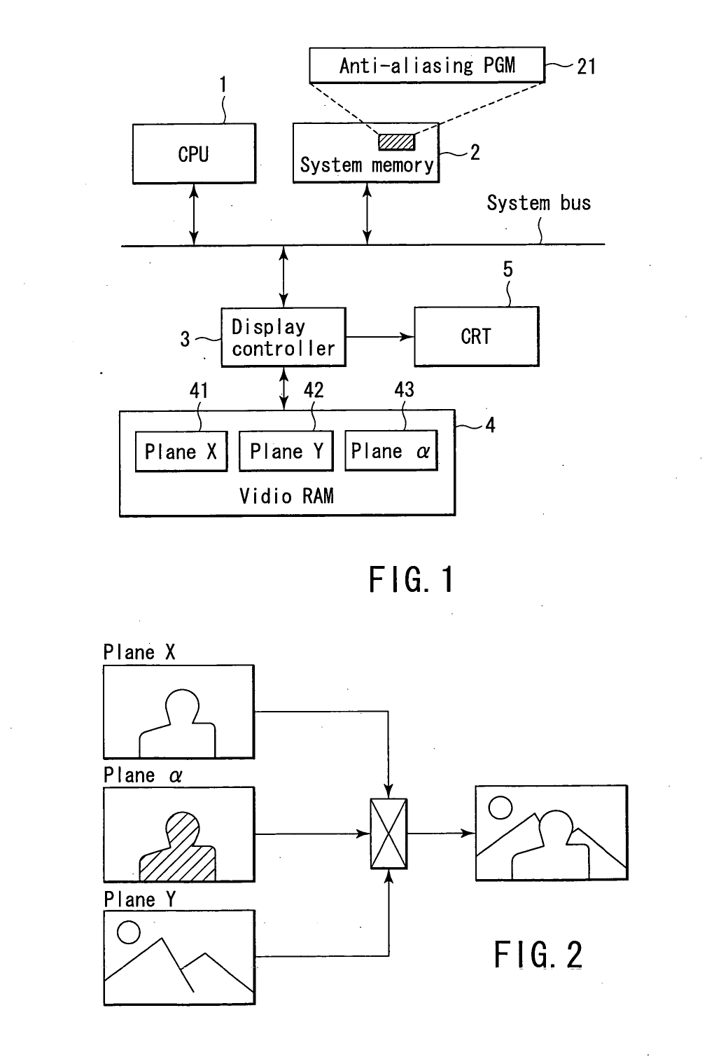

FIG. 1 shows a configuration of display control of an information processing apparatus according to the embodiment of the present invention.

The information processing apparatus is, for example, a desktop-type personal computer and comprises a CPU 1, a system memory 2 and a display controller 3. These are connected to a system bus provided in the computer and can-make communications with each other via the system bus. A video RAM 4 and a CRT display 5 are connected to the display controller 3. The CRT display 5 is an external device arbitrarily connected via a connector provided on, for example, a rear face of a housing of the computer body.

The CPU 1 controls the entire body of the information processing apparatus and executes programs stored in the system memory 2. The programs include an anti-aliasing program 21 to be described later.

The system memory 2 is a main memory device such as a RAM, temporarily storing various kinds of programs executed by the CPU 1 and various kinds of data used in the programs.

The display controller 3 controls an output side of a user interface provided by the information processing apparatus. The display controller 3 stores the image data formed by the CPU 1 in the video RAM 4, and also allows the image data stored in the video RAM 4 to be displayed on the CRT display 5 in accordance with an instruction from the CPU 1. The display controller 3 is a display device having a function of synthesizing two or more different images at an arbitrary mixture ratio or what is called an a channel.

The display device having the α channel is employed to synthesize, for example, a person and a background as shown in FIG. 2. The display device is composed of at least two planes (plane X and plane Y in this embodiment) and a plane of the α channel determining the mixture ratio (plane α). In other words, display data of each of planes X and Y corresponds to the data of the α channel determining the mixture ratio, at each pixel of the display data. The display device displays the image data while successively executing the middle color calculation of each pixel with hardware or a processor exclusive for the operation. When the person and the background shown in FIG. 2 are synthesized, data of the person, data of the background, and mask data of a personal outline are transferred to plane X, plane Y and plane α, respectively.

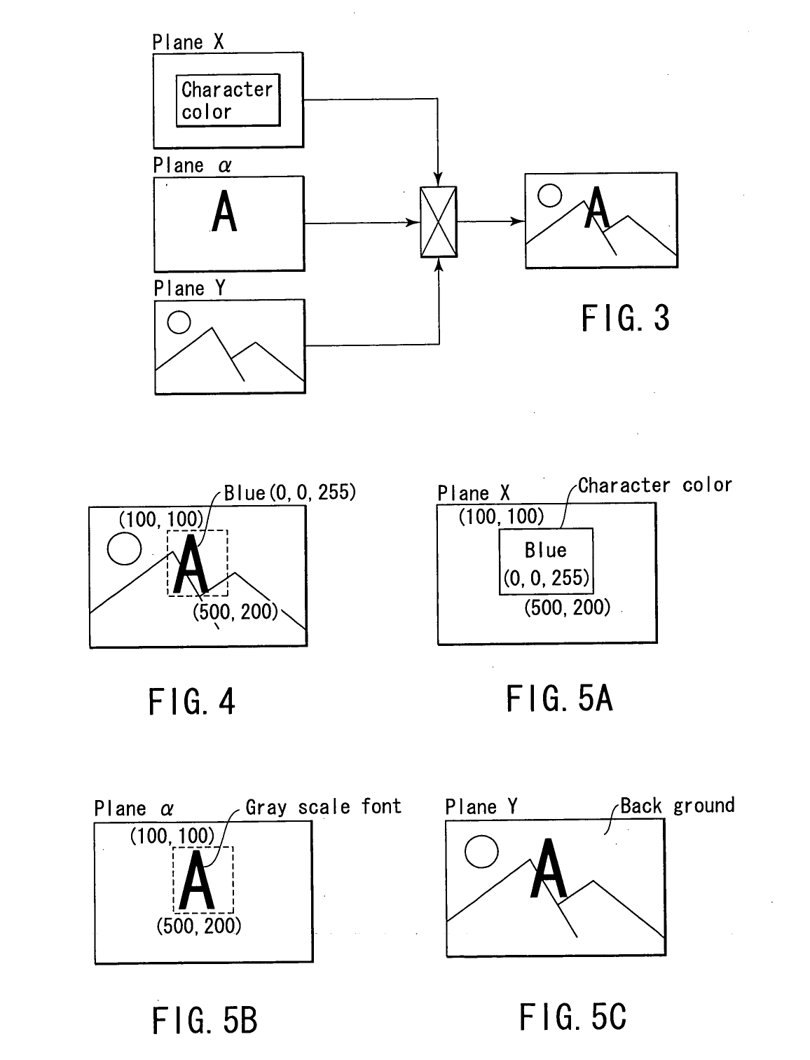

The information processing apparatus of this embodiment executes the character display subjected to anti-aliasing as shown in FIG. 3, by employing the synthesizing function of the display device having the α channel. In other words, the background is transferred to plane Y, the character color to a character display area of plane X, and gray scale font data formed by executing anti-aliasing of a character to be displayed to plane α, such that the character subjected to anti-aliasing is superposed on the background and displayed. For this reason, the video RAM 4 includes three data memory areas 41 to 43 to store the data of plane X, plane Y and plane α individually. The anti-aliasing program 21 executes the character display control by the data transfer to each of the planes.

More specifically, a character display controlling method of the information processing apparatus according to this embodiment in a case of, for example, drawing the character subjected to anti-aliasing with blue color (0, 0, 255) in a range (100, 100) to (500, 200) of the screen, as shown in FIG. 4, will be described. An initial state of plane X is undefined. An initial state of plane Y is loaded with background bitmap. The a channel is filled with 0. In this case, only plane Y is displayed.

The anti-aliasing program 21 first fills the character display area (100, 100) to (500, 200) of plane X with blue color (0, 0, 255) as shown in FIG. 5A. Next, the anti-aliasing program 21 executes the anti-aliasing operation about the character to be displayed and transfers the gray scale font data subjected to the anti-aliasing operation to the character display area of the α channel as shown in FIG. 5B. In these simple steps, the character subjected to anti-aliasing is superposed on a background shown in FIG. 5C and displayed on the CRT display 5.

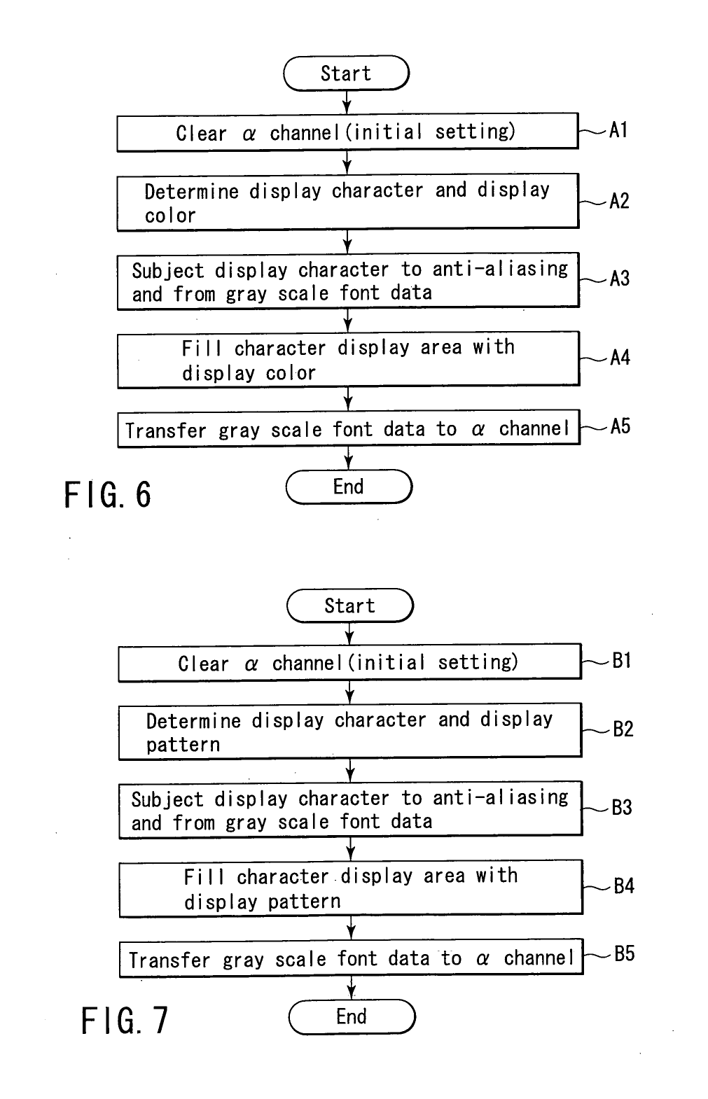

FIG. 6 is a flowchart of steps of the character display controlling method in the information processing apparatus according to this embodiment.

The anti-aliasing program 21 first clears the a channel as initial setting (step A1). After the initial setting, the anti-aliasing program 21 determines a display character and a display color (step A2), and subjects this character to anti-aliasing and forms the gray scale font data (step A3).

The anti-aliasing program 21 fills the character display area with the display color determined in step A2 (step A4) and transfers the gray scale font data formed in step A3 to the α channel (step A5).

According to the character display controlling method, the character subjected to anti-aliasing can be displayed in less steps than the prior art.

Superposing the character of a single color on the background has been described above. In the character display controlling method, however, a patterned character subjected to anti-aliasing can also be displayed simply. For example, in a case where a character subjected to anti-aliasing is patterned and drawn in the range (100, 100) to (500, 200), similarly to the above-described case, the bitmap of the pattern is first transferred to the range (100, 100) to (500, 200), i.e. the character display area of plane X. After that, the gray scale font data subjected to the anti-aliasing operation may be transferred to the character display area of the α channel.

FIG. 7 is a flowchart of steps of the character display controlling method in the case of displaying a patterned character subjected to anti-aliasing.

The anti-aliasing program 21 first clears the α channel as initial setting (step B1). After the initial setting, the anti-aliasing program 21 determines a display character and a display pattern (step B2), and subjects this character to anti-aliasing and forms the gray scale font data (step B3).

The anti-aliasing program 21 fills the character display area with the display pattern determined in step B2 (step B4) and transfers the gray scale font data formed in step B3 to the α channel (step B5).

According to the character display controlling method, the patterned character subjected to anti-aliasing which has required a considerable amount of operations in the prior art can also be displayed very easily.

Superposing the character on the background has been described in the embodiment. In the character display controlling method, however, vector data or bitmap data subjected to anti-aliasing, other than the character, can naturally be processed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a display device;
an anti-aliasing unit configured to subject character data to be displayed on the display device to anti-aliasing;
a synthesizing unit configured to synthesize first display data to be displayed on the display device and second display data to be displayed on the display device in accordance with mixture ratio data representing a mixture ratio of a display color of the first display data to a display color of the second display data; and
a display controlling unit configured to supply the character data subjected to anti-aliasing by the anti-aliasing unit to the synthesizing unit as the mixture ratio data in order to cause the synthesizing unit to generate display data superposing the character data, subjected to anti-aliasing, painted in the display color of the first display data on the background composed of the second display data, and display the generated display data on the display device.

2. The apparatus according to claim 1, wherein the display controlling unit paints an arbitrary color to the character data by changing the display color of the first display data stored in the first memory area.

3. The apparatus according to claim 1, further comprising a memory area configured to store the first display data,
wherein the display controlling unit draws a pattern to the character data by storing the display data formed from data of a predetermined pattern in the memory area.

4. A character display controlling method of a display device having an α channel, comprising:
transferring display data representing a character color to plane X, display data representing a background color to plane Y, and gray scale font data formed by subjecting character data to be displayed to anti-aliasing to plane α; and
forming mixture data subjected to anti-aliasing by superposing the character data painted in a display color of the display data of the plane X on the background composed of the display data of the plane Y.

5. The method according to claim 4, wherein the character superposed on the background is painted in an arbitrary color by changing the display color of the display data of the plane X.

6. The method according to claim 5, wherein the character superposed on the background is drawn by a pattern by transferring display data formed from data of a predetermined pattern to the plane X.
